(19) United States
(12) Patent Application Publication
(10) Pub. No.: US 2012/0304694 A1
(43) Pub. Date: Dec. 6, 2012

(54) METHODS FOR PRODUCING A DESIGN IN A SINTERED PRODUCT

(75) Inventor: Andrew Derrig, Lynbrook, NY (US)

(73) Assignee: FREDERICK GOLDMAN INC., New York, NY (US)

(21) Appl. No.: 13/486,587

(22) Filed: Jun. 1, 2012

Related U.S. Application Data
(60) Provisional application No. 61/492,197, filed on Jun. 1, 2011.

(51) Int. Cl. C04B 35/622; A44C 25/00; B22F 1/00; C04B 35/84; B22F 3/12; B22F 3/26

(52) U.S. Cl. 63/35; 419/38; 419/27; 419/10; 264/653; 427/228; 264/647

(57) ABSTRACT

In a method for producing jewelry articles, forming a predetermined shape from a plurality of sinterable materials, heating the plurality of sinterable materials to a first temperature and for a first time period sufficient to produce a substrate that retains the predetermined shape during manipulation, cooling the substrate to a second temperature at which the substrate is manipulable, manipulating the substrate to incorporate at least one design feature in the substrate, heating the substrate to a third temperature and for a second time period sufficient to sinter the substrate, and cooling the substrate to obtain the jewelry article.

### CROSS-REFERENCE TO RELATED APPLICATIONS

The present application claims the benefit of U.S. Provisional Application Ser. No. 61/492,197 filed on 1 Jun. 2011, which is incorporated herein by reference in its entirety.

### BACKGROUND OF THE INVENTION

1. Field of the Invention

The present invention relates generally to methods for producing sintered products comprising an ornamental design. In preferred embodiments, said sintered products are jewelry articles.

2. Background

Sintering is a process commonly used for the production of metallic articles such as jewelry. Most transition metals can be sintered. Sintering was originally developed as an alternative to casting from molten metal or forging at softening temperatures and may involve, e.g., welding together of small particles of metal by heating to a temperature below the melting point of the metal, under appropriate atmospheric conditions. Sintering requires heating of the metal to a temperature corresponding to an range of between about 66% and about 80% of its melting point. The bonding between atoms is the same as that produced by casting. Sintering generally involves powder particles, which may be produced by gas-assisted atomization. In this method, the metal is first heated above its liquidation temperature. The molten metal then flows through a nozzle whereupon a high-pressure gas stream breaks up the metal into small droplets, which upon cooling become metal powders. Gas pressure can be adjusted to produce droplets having the required dimensions, with increased gas pressure producing finer droplets as described, for example, in U.S. Pat. No. 6,544,315. While techniques for creating sintered jewelry articles are known to the skilled artisan, an appreciable need exists for methods of producing such items prior to sintering. Such techniques would afford greater control and manipulation over the ornamental and aesthetic designs and patterns available in the manufacture of jewelry articles. The present invention addresses that need.

### SUMMARY

One aspect of the present disclosure relates to a method for producing a jewelry article, comprising forming a predetermined shape from a plurality of materials, heating the plurality of materials to a first temperature and for a first period of time sufficient to produce a substrate or part that retains the predetermined shape during manipulation, cooling the substrate or part such that the substrate or part is manipulable, manipulating the substrate or part to incorporate at least one design feature in the substrate or part, heating the substrate or part to a second temperature and for a second period of time sufficient to sinter the substrate or part, and cooling the substrate or part to obtain the jewelry article.

In another aspect the materials are sinterable materials, such as, for example, powdered metals or powdered materials with metallic properties.

In another aspect of the present disclosure the heating of the plurality of materials to the first temperature and for the first period of time is sufficient to result in a pre-sintering but not sufficient to cause a sintering of at least a portion of the plurality of materials.

In another aspect, the first temperature is a first predetermined temperature. In another aspect, the first period of time is a first predetermined period of time.

In another aspect, the second temperature is a second predetermined temperature. In another aspect, the second period of time is a second predetermined period of time.

In another aspect, the first temperature and the first period of time will vary depending on the plurality of materials and/or pressure.

In another aspect, the second temperature and the second period of time will vary depending on the plurality of materials and/or pressure.

In another aspect, the first predetermined temperature is between about ambient temperature and about 650° C.

In another aspect, the first predetermined temperature is between about ambient temperature and about 800° C.

In another aspect, the first predetermined period of time is between 1 and 72 hours.

In another aspect, the second predetermined temperature is between about ambient temperature and about 1450° C.

In another aspect, the second predetermined temperature is between about ambient temperature and about 2200° C.

In another aspect, the second predetermined period of time is between 2 and 72 hours.

In another aspect, the plurality of materials comprise at least one of tungsten carbide, cobalt, tungsten, titanium, titanium carbide, zirconium, tantalum, aluminum, rhodium, gold, silver, platinum, palladium, iridium, iron, stainless steel, cobalt chrome, cobalt chromium, nickel, nitinol, aluminum, aluminum carbide, vanadium, ruthenium, copper, zinc, tin, German silver, niobium, molybdenum, rhenium and hafnium, in various forms, including, for example, powdered form.

In another aspect, the plurality of materials includes at least one matrix binder selected from the group consisting of nickel, cobalt, titanium, zirconium, tantalum, aluminum, rhodium, gold, silver, platinum, palladium, iridium, iron, stainless steel, cobalt chrome, cobalt chromium, nickel, nitinol, aluminum, vanadium, ruthenium, copper, zinc, tin, German silver, niobium, molybdenum, rhenium and hafnium, in various forms, including, for example, powdered form.

In another aspect, the plurality of materials includes a binder selected from the group consisting of a polymer, plastic, binder, wax, rubber and resin.

In another aspect, the binder leaches out of the substrate or part prior to obtaining the jewelry article.

In another aspect, the substrate comprises about 85%-90% Tungsten Carbide and the second temperature is between 1300 and 1500 degrees C.

In another aspect, the design feature can be functional or non-functional.

In another aspect, the manipulating is a first manipulation and further comprising performing a second manipulation on the substrate or part.

In another aspect, the second manipulation is performed after the second cooling.

In another aspect, the first temperature is a first predetermined temperature that will vary depending on the type of materials used and the pressure.

In another aspect, the first temperature is a plurality of temperatures for varying periods of time.

In a further embodiment, the first temperature varies such that the temperature ranges between about 0° C. to about 300° C. for 2 hours, between about 300° C. to about 400° C. for 1.5 hours, between about 400° C. to about 650° C. for 3 hours and at about 650° C. for 2 hours.

In another aspect, the heating to the first temperature occurs for a time period exceeding about 2 hours. In another aspect, the heating to the first temperature occurs for a time period between about 1 hour and about 18 hours

In another aspect, the second temperature is a plurality of temperatures for varying periods of time.

In a further embodiment, the second temperature varies such that the temperature ranges between about 0° C. to about 800° C. for 4 hours, between about 800° C. to about 1000° C. for 2 hours, between about 1000° C. to about 1200° C. for 2 hours, between about 1200° C. to about 1400° C. for 2 hours, between about 1400° C. to about 1450° C. for 1 hour and at about 1450° C. for 4 hours.

In another aspect, the cooling is performed in an environment having a temperature either above ambient temperature, below ambient temperature, at ambient temperature, or any combination.

In another aspect, the first cooling can take from about 2-15 hours from the first temperature.

In yet another aspect, the second cooling can take from about 2-15 hours from the second temperature.

In another aspect, the cooling can be accelerated using artificial cooling, including, for example, air conditioning, liquid nitrogen or other chemical compounds, an ice bath, a wash or dousing with water or another liquid or gas.

In another aspect, the cooling can be accomplished by any other cooling method now known or hereafter discovered or developed.

In another aspect, the first manipulation step is selected from the group consisting of patterning, surface modulating, etching, carving, faceting, cutting, pressing, molding, casting, striking, extruding, inlaying, shaping, polishing, tumbling, grinding, drilling, sculpting, scoring, scraping, rubbing sanding, buffing and filing.

In another aspect, the second manipulation step is selected from the group consisting of patterning, surface modulating, etching, carving, faceting, cutting, pressing, molding, casting, striking, extruding, inlaying, shaping, polishing, tumbling, grinding, drilling, sculpting, scoring, scraping, rubbing, sanding, buffing and filing.

In another aspect, the jewelry article is a ring, ornamental ring, engagement ring, toe ring, watch, bracelet, necklace, pendant, charm, armlet, brocade, pin, clip, hairclip, fob, ornamental piercing, earring, nose ring, dog tag, amulet, bangle bracelet, cuff bracelet, link bracelet, cuff link, key chain, money clip, cell phone charm, signet ring, class ring, friendship ring or purity ring.

In another aspect, the jewelry article is a wedding band.

In another aspect, the jewelry article is optionally layered with a first coating.

In another aspect, the first coating is deposited onto the substrate using electroplating, physical vapor deposition (PVD) or chemical vapor deposition (CVD).

In another aspect, the first coating is optionally layered with a second coating.

In another aspect, the second coating is deposited onto the first coating using electroplating, physical vapor deposition (PVD) or chemical vapor deposition (CVD).

In another aspect, the substrate comprises at least one of a metal salt, metal alloy, metal carbide, metal nitride, metal sulfate, metal chlorate, metal sulfide and metal boride.

In another aspect, the first coating is selected from the group consisting of a metal salt, metal alloy, metal carbide, metal nitride and metal boride.

In another aspect, the second coating is selected from the group consisting of a metal salt, metal alloy, metal carbide, metal nitride, metal sulfate, metal chlorate, metal sulfide and metal boride.

Another aspect of the present invention relates to a method for producing a jewelry article, comprising forming a part, comprising a plurality of materials and a binder, into a first predetermined shape that has sufficient stability to allow its manipulation prior to sintering such that a second predetermined shape can be formed, manipulating the part to form the second predetermined shape, heating the part to a first temperature and for a first time period sufficient to sinter the part, and cooling the part to obtain the jewelry article.

In another aspect, the first temperature is a predetermined temperature and the first time period is a predetermined time period.

In another aspect, the predetermined temperature and/or the predetermined time period may vary depending on the type of materials and pressure.

In another aspect, the second predetermined shape is a design feature.

In another aspect, the design feature can be functional or non-functional.

In another aspect, the manipulating is a first manipulation and further comprising performing a second manipulation on said substrate or part.

In another aspect, the second manipulation is performed after the cooling.

In another aspect, the predetermined temperature is between about ambient temperature and about 1450° C.

In another aspect, the predetermined temperature is between about ambient temperature and about 2200° C.

In another aspect, the predetermined time period is between 2 and 72 hours.

In another aspect, the substrate is 85%-90% Tungsten Carbide and the first temperature is 1300 to 1500 degrees C.

In another aspect, the cooling is performed in an environment having a temperature either above ambient temperature, below ambient temperature, at ambient temperature, or any combination. In another aspect, the cooling can take from about 2-15 hours from the first temperature. In another aspect, the cooling can be accelerated using artificial cooling, including, for example, air conditioning, liquid nitrogen or other chemical compounds, an ice bath, a wash or dousing with water or another liquid or gas. In another aspect, the cooling can be accomplished by any other cooling method now known or hereafter discovered or developed.

In another aspect, the heating occurs for a time period between about 2 hour and about 72 hours.

In another aspect, the first manipulation step is selected from the group consisting of patterning, surface modulating, etching, carving, faceting, cutting, pressing, molding, casting, striking, extruding, inlaying, shaping, polishing, tumbling, grinding, scraping, rubbing, sanding, buffing and filing.

In another aspect, the second manipulation step is selected from the group consisting of patterning, surface modulating, etching, carving, faceting, cutting, pressing, molding, casting, striking, extruding, inlaying, shaping, polishing, tumbling, grinding, scraping, rubbing, sanding, buffing and filing.

In another aspect, the jewelry article is a ring, ornamental ring, engagement ring, toe ring, watch, bracelet, necklace, pendant, charm, armlet, brocade, pin, clip, hairclip, fob, ornamental piercing, earring, nose ring, dog tag, amulet, bangle bracelet, cuff bracelet, link bracelet, cuff link, key chain, money clip, cell phone charm, signet ring, class ring, friendship ring or purity ring.

In another aspect, the jewelry article is a wedding band.

In another aspect, the metallic article is optionally layered with a first coating.

In another aspect, the first coating is deposited onto the substrate using electroplating, physical vapor deposition (PVD) or chemical vapor deposition (CVD).

In another aspect, the first coating is optionally layered with a second coating.

In another aspect, the second coating is deposited onto the first coating using electroplating, physical vapor deposition (PVD) or chemical vapor deposition (CVD).

In another aspect, the substrate comprises at least one of a metal salt, metal alloy, metal carbide, metal nitride, metal sulfate, metal chlorate, metal sulfide and metal boride.

In another aspect, the first coating is selected from the group consisting of a metal alloy, metal carbide, metal nitride and metal boride.

In another aspect, the second coating is selected from the group consisting of a metal alloy, metal carbide, metal nitride and metal boride.

In another aspect, the substrate includes a binder selected from the group consisting of a polymer, plastic, binder, wax, rubber and resin.

In another aspect, the binder material leaches out of the substrate prior to obtaining the jewelry article.

In another aspect, the plurality of materials comprises at least one of tungsten carbide, cobalt, tungsten, titanium, titanium carbide, zirconium, tantalum, aluminum, rhodium, gold, silver, platinum, palladium, iridium, iron, stainless steel, cobalt chrome, cobalt chromium, nickel, nitinol, aluminum, aluminum carbide, vanadium, ruthenium, copper, zinc, tin, German silver, niobium, molybdenum, rhenium and hafnium, in various forms, including, for example, powdered form.

In another aspect, the plurality of materials includes at least one matrix binder selected from the group consisting of nickel, cobalt, titanium, zirconium, tantalum, aluminum, rhodium, gold, silver, platinum, palladium, iridium, iron, stainless steel, cobalt chrome, cobalt chromium, nickel, nitinol, aluminum, vanadium, ruthenium, copper, zinc, tin, German silver, niobium, molybdenum, rhenium and hafnium, in various forms, including, for example, powdered form.

In another aspect, the jewelry article comprises at least 90% by weight of tungsten carbide, cobalt, tungsten, titanium, titanium carbide, zirconium, tantalum, aluminum, rhodium, gold, silver, platinum, palladium, iridium, iron, stainless steel, cobalt chrome, cobalt chromium, nickel, nitinol, aluminum, aluminum carbide, vanadium, ruthenium, copper, zinc, tin, German silver, niobium, molybdenum, rhenium and/or hafnium, in various forms, including, for example, powdered form.

In another aspect, the jewelry article comprises less than 90% by weight of tungsten carbide, cobalt, tungsten, titanium, titanium carbide, zirconium, tantalum, aluminum, rhodium, gold, silver, platinum, palladium, iridium, iron, stainless steel, cobalt chrome, cobalt chromium, nickel, nitinol, aluminum, aluminum carbide, vanadium, ruthenium, copper, zinc, tin, German silver, niobium, molybdenum, rhenium and/or hafnium, in various forms, including, for example, powdered form.

In another aspect, the jewelry article comprises less than 40%, between 40 and 50%, between 50 and 60%, between 60 and 70%, between 70 and 80%, between 80 and 90% and between 90 and 96% by weight of tungsten carbide, cobalt, tungsten, titanium, titanium carbide, zirconium, tantalum, aluminum, rhodium, gold, silver, platinum, palladium, iridium, iron, stainless steel, cobalt chrome, cobalt chromium, nickel, nitinol, aluminum, aluminum carbide, vanadium, ruthenium, copper, zinc, tin, German silver, niobium, molybdenum, rhenium and/or hafnium, in various forms, including, for example, powdered form.

In another aspect, the jewelry article comprises less than 10% by weight of the matrix binder. In another aspect, the jewelry article comprises greater than 5%, between 10 and 20%, between 20 and 30%, between 30 and 40%, between 40 and 50%, between 50 and 60%, between 60 and 70%, and greater than 70% by weight of the matrix binder, in various forms, including, for example, powdered form.

In another aspect, the second manipulation step results in a surface that is contiguous and disposed circumferentially.

Another aspect of the present disclosure relates to a partially sintered jewelry article, comprising a substrate or part having a design feature, prepared by a process comprising forming a predetermined non-functional shape from a plurality of materials, heating the plurality of materials to a first temperature and for a first period of time sufficient to produce a substrate or part that retains the predetermined shape during manipulation, cooling the substrate or part such that the substrate or part is manipulable, manipulating the substrate or part to incorporate at least one design feature in the substrate or part, heating the substrate or part to a second temperature and for a second period of time sufficient to sinter the substrate or part, and cooling the substrate or part.

In another aspect, the first manipulation is performed using at least one of a CNC machine, a laser, photo lithography, a water jet, a lathe, a tumbler, a drill, a saw, a file, a tool, power tools and hand tools.

In another aspect, the manipulation is performed using at least one of a CNC machine, a laser, photo lithography, a water jet, a lathe, a tumbler, a drill, a saw, a file, a tool, power tools and hand tools.

In another aspect, the method is performed in an atmosphere comprising one or more of air, argon, nitrogen, and oxygen.

In another aspect, the substrate or part includes a binder selected from the group consisting of a polymer, plastic, binder, wax, rubber and resin.

In another aspect, the binder is selected from the group consisting of carving wax, injection wax, ferris wax, matt wax, a wax sheet, a wax wire, clay, mold rubber, Castaldo® rubber, Contenti rubber, plastic casting and plastic molding.

In another aspect, the substrate or part includes a binder selected from the group consisting of a polymer, plastic, binder, wax, rubber and resin.

In another aspect, the substrate or part is 85%-90% Tungsten Carbide and the second temperature is between about 1300° C. and about 1500° C. degrees C.

In another aspect, the part is 85%-90% Tungsten Carbide.

In another aspect, the substrate or part is 85%-90% Tungsten Carbide and the second temperature is about 1300° C. to about 1500° C.

In another aspect, the heating to the second temperature occurs for a time period between about 1 hour and about 18 hours.

In another aspect, the cooling is to a temperature below ambient temperature.

In another aspect, the cooling is to a temperature above ambient temperature.

In another aspect, the substrate or part is cooled by natural cooling.

In another aspect, the substrate or part is cooled by a mechanical cooling device.

In another aspect, the manipulation includes adding a setting to the substrate or part, such as, for example, a channel, bezel, prong or pave setting. Any known or future developed technique for setting gemstones or other materials, such as, for example, cubic zirconia, can be used, including, for example, forming the setting from the substrate material or from other material coupled to the substrate.

### BRIEF DESCRIPTION OF THE DRAWINGS

FIG. 1 depicts one embodiment of a process for producing a piece of jewelry.

FIG. 2. depicts one embodiment of a hot/cold isostatic pressing device.

FIG. 3 depicts one embodiment of a graph of the temperatures used to heat a 85%-90% Tungsten Carbide sample.

FIG. 4 depicts one embodiment of a sample that is carved into a gem setting.

FIG. 5A depicts one embodiment of a sample milled into a channel setting.

FIG. 5B depicts a side view of one embodiment of a sample milled into a channel setting.

FIG. 5C depicts a side view of one embodiment of a sample milled into a channel setting.

FIG. 6A depicts one embodiment of a sample milled with an “odd shaped” precious metal inlay in the top surface of the sample.

FIG. 7 depicts one embodiment of a jewelry piece.

FIG. 8 depicts one embodiment of a jewelry piece.

### DESCRIPTION OF ILLUSTRATIVE EMBODIMENTS

The present invention relates generally to methods for producing sintered products comprising an ornamental design. In preferred embodiments, said sintered products are jewelry articles. In preferred embodiments, said jewelry articles may be modulated, for instance, through patterning, layering, inlaying, cutting or other metallurgical techniques known in the art.

As used herein, the singular forms “a”, “an” and “the” are intended to include the plural forms as well, unless otherwise indicated. Additionally, the use of “or” is intended to include “and/or”, unless otherwise indicated.

The present disclosure is directed to methods for producing a jewelry article that may be formed prior to sintering the substrate or part used to obtain said article. In some embodiments, said jewelry article is subjected to a first and/or a second manipulation step selected from patterning, surface modulating, etching, carving, faceting, cutting, pressing, molding, casting, striking, extruding, inlaying, shaping, polishing, tumbling, grinding, scraping, rubbing sanding, buffing, drilling, sculpting, scoring and filing. In some embodiments, said jewelry article is a ring, ornamental ring, engagement ring, toe ring, watch, watchcase, bracelet, necklace, chain, pendant, charm, armlet, brocade, pin, clip, hairclip, carved bead, fob, ornamental piercing, earring, nose ring, body jewelry, dog tag, amulet, bangle bracelet, cuff bracelet, link bracelet, cuff link, tie clip, tie pin, tie tack, key chain, money clip, cell phone charm, cutlery, writing instrument, pen, signet ring, class ring, friendship ring or purity ring.

The present disclosure advantageously allows for the shaping and manipulation of a substrate or part into a jewelry article prior to sintering using any tool or machine suitable for patterning, surface modulating, etching, carving, faceting, cutting, pressing, molding, casting, striking, extruding, inlaying, shaping, polishing, tumbling, grinding, scraping, rubbing, sanding, buffing, drilling, sculpting, scoring and filing. In some embodiments, said shaping and manipulation is performed using at least one of a CNC machine, a laser, photo lithography, a water jet, a lathe, a tumbler, a drill, a saw, a file, power tools and hand tools.

### Definitions

In the description herein, a number of terms are used. In order to provide a clear and consistent understanding of the specification and claims, the following definitions are provided:

Ambient Temperature: As used herein, “ambient temperature” refers to the temperature of the surrounding environment. In preferred embodiments, ambient temperature refers to a temperature between about 0° C. and about 300° C. In certain embodiments, ambient temperature includes ambient room temperature, which generally ranges between about 18° C. (64.4° F.) and about 30° C. (86° F.).

Binder: Refers to any type of malleable material that is used to blend and hold powdered materials together such as, but not limited to, paraffin wax, resins, or any other material capable of binding powdered metals or materials having metallic properties together. U.S. Pat. No. 6,928,734, titled “JEWELRY RING AND METHOD OF MANUFACTURING THE SAME,” which is herein incorporated in its entirety by reference, describes some binder materials.

Electroplating: Refers to the process of moving metal ions in solution via an electrical or conductive field to coat an object. This process is used for the deposition of a material, such as a metal or metal alloy, for imparting a desirable property onto said object, including but not limited to resistance to scratching, corrosion, chipping and dulling.

Engraving: Refers to any modification of the surface of an object using a tool.

Hardness: Refers to resistance of a material to indentation, deformation, or abrasion. Hardness can be measured by the Mohs scale, Rockwell scale, Brinell number, or Vickers scale, or some other scientifically recognized measurement scale or basis. Hardness measurements include the measurement of indentation hardness, scratch hardness or rebound hardness. Hardness is dependent on ductility, elasticity, plasticity, strain, strength, toughness, viscoelasticity, and viscosity of the metals tested.

Jewelry: As used herein, “jewelry” refers to personal adornments worn for ornament or utility. Jewelry includes but is in no way limited to rings, ornamental rings, engagement rings, toe rings, watches, watchcases, bracelets, necklaces, chains, pendants, charms, armlets, brocades, pins, clips, hairclips, carved beads, fobs, ornamental piercings, earrings, nose rings, body jewelry, dog tags, amulets, bangle bracelets, cuff bracelets, link bracelets, cuff links, tie clips, tie pins, tie tacks, key chains, money clips, cell phone charms, cutlery, writing utensils, pens, charms, signet rings, class rings, friendship rings or purity rings.

Manipulable: As used herein, a substance that is “manipulable” is one capable of being patterned, surface modulated, etched, carved, faceted, cut, pressed, molded, cast, stricken, extruded, inlayed, shaped, polished, grinded, scraped, rubbed, sanded, buffed, drilled, sculpted, scored and/or filed. In preferred embodiments, said substance is a substrate or part for use in the present disclosure. In one embodiment, manipulation includes adding a setting to the substrate or part, such as, for example, a channel, bezel, prong or pave setting. Any known or future developed technique for setting gemstones or other materials, such as, for example, cubic zirconia, can be used, including, for example, forming the setting from the substrate material or from other material coupled to the substrate.

Matrix Binder: Refers to metals or materials having metallic properties used as part of a matrix that binds metals or materials having metallic properties to tungsten carbide, such as, but not limited to at least one of nickel, cobalt, titanium, zirconium, tantalum, aluminum, rhodium, gold, silver, platinum, palladium, iridium, iron, stainless steel, cobalt chrome, cobalt chromium, nickel, nitinol, aluminum, vanadium, ruthenium, copper, zinc, tin, German silver, niobium, molybdenum, rhenium and hafnium, or any other suitable matrix binder material, in various forms, including, for example, powdered form.

Metal Alloy: As used herein, a “metal alloy” is a mixture of two or more metals or of substances with metallic properties. In some embodiments, metal alloys for use in the present disclosure comprise at least one transition metal including but in no way limited to tungsten, cobalt, tungsten, titanium, zirconium, tantalum, aluminum, rhodium, gold, silver, platinum, palladium, iridium, iron, stainless steel, nickel, niobium, vanadium, ruthenium, copper, zinc, tin, molybdenum, hafnium and rhenium. In certain embodiments, said metal alloy is selected from a gold alloy, silver alloy, platinum alloy, palladium alloy and iron alloy. In further embodiments, a stainless steel alloy is selected from types 18-8, 304 and 316. In another embodiment, the metal alloy is brass or bronze.

Metal Carbide: A “metal carbide” is a compound comprising at least one transition metal or substance with metallic properties and carbon or carbon containing chemical group. In certain embodiments, metal carbides for use in the present disclosure include but are in no way limited to tungsten carbide, tungsten-copper carbide, tungsten-silver-copper carbide, titanium carbide, zirconium carbide, niobium carbide, hafnium carbide, vanadium carbide, tantalum carbide, chromium carbide, aluminum carbide and molybdenum carbide.

Metal Nitride: A “metal nitride” is a compound comprising at least one transition metal or substance with metallic properties and nitrogen or nitrogen containing chemical group. In some embodiments, metal nitrides for use in the present disclosure include but are in no way limited to titanium nitride, chromium nitride, zirconium nitride, tungsten nitride, gold nitride, silver nitride, aluminum nitride, vanadium nitride, tantalum nitride, aluminum-titanium-nitride, titanium-aluminum-nitride and titanium-carbon-nitride.

Metal Salt: A “metal salt” is a compound comprising at least one cationic, transition metal or cation with metallic properties and an anion. In some embodiments, metal salts for use in the present disclosure comprise at least one transition metal including but in no way limited to tungsten, cobalt, titanium, zirconium, tantalum, aluminum, rhodium, gold, silver, platinum, palladium, iridium, iron, stainless steel, cobalt, chromium, aluminum, vanadium, ruthenium, copper, zinc, tin, nickel, niobium, molybdenum, rhenium and hafnium.

Metal Sulfide: A “metal sulfide” is a compound comprising at least one transition metal or substance with metallic properties and sulfur or sulfur containing chemical group.

Metal Injection Molding (MIM): Refers to a metalworking process wherein a ground and/or powdered metal is mixed with a measured amount of a binder to comprise a substrate or part capable of being manipulated, for instance, using plastic processing equipment.

Pre-Sintering or Pre-Sintered: Refers to a process where a plurality of metal powders and/or powders comprising components with metallic properties are at least partially fused together, but not to the same level as fully sintered metal powders and/or powders comprising components with metallic properties. In terms of hardness, pre-sintering provides the fusing of at least two metal powders and/or powders comprising components with metallic properties to a hardness that is less than when the at least two metal powders and/or powders comprising components with metallic properties are fully sintered.

Polishing: As used herein, “polishing” refers to the process of smoothing and/or increasing the luster of a surface by the application of physical or chemical action or agent to a substance.

Sintering: As used herein, “sintering” refers to the formation of a homogeneous mass by heating metal powders and/or powders comprising components with metallic properties, including under pressurized conditions, in the absence of melting all of these substances.

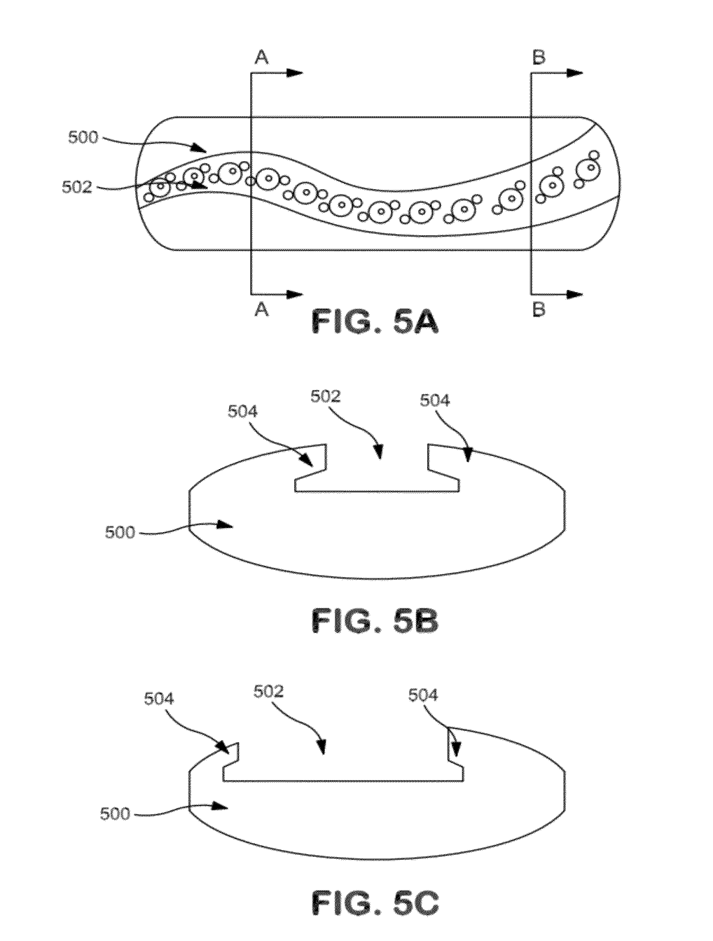

Undercutting: Refers to the process of cutting a groove in a sample to form a cavity, or negative space, under the surface of the sample. The negative space being defined by an open area partially confined by the sample on at least two sides and a portion of the sample on another side as depicted by element 504 in FIG. 5A.

Vapor Deposition: Refers to a general process for the deposition of compounds onto a designated substrate or part. In preferred embodiments, the use of vapor deposition in the context of the present disclosure refers to chemical vapor deposition (CVD), physical vapor deposition (PVD), plasma enhanced chemical vapor deposition (PECVD), diamond CVD coating, ionized physical vapor deposition (IPVD), sputtering and thermal evaporation. In certain embodiments, vapor deposition is optionally used to add a first and/or a second layer to a substrate or part used to produce a jewelry article. In preferred embodiments, said first and/or second layer comprises a metal coating comprising one or more of tungsten, cobalt, tungsten, titanium, zirconium, tantalum, aluminum, rhodium, gold, silver, platinum, palladium, iridium, iron, stainless steel, nickel, niobium, vanadium, ruthenium, copper, zinc, tin, hafnium, molybdenum and rhenium. In certain embodiments, said metal alloy is selected from a gold alloy, silver alloy, platinum alloy, palladium alloy and iron alloy. In further embodiments, a stainless steel alloy is selected from types 18-8, 304 and 316.

In addition to these terms, other terms and processes are defined in O'Conner, Harold, “Jeweler's Bench Reference,” ISBN-10: 0918820030 (1977) which is incorporated herein by reference, as well as, McCreight, Tim, “The Complete Metalsmith: An Illustrated Handbook,” ISBN-10: 9780871922403 (1991) which is also incorporated herein by reference.

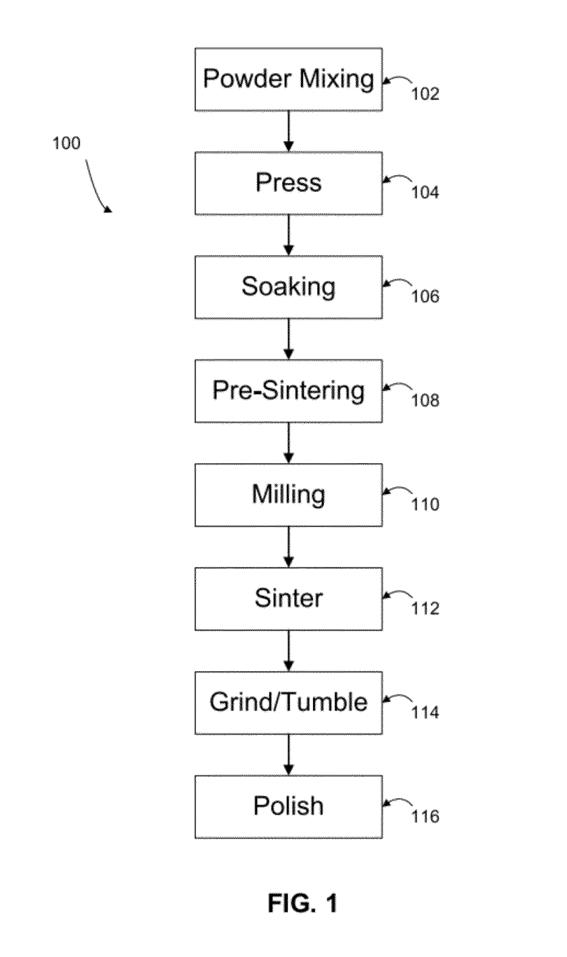

FIG. 1 depicts one embodiment of a process for producing a piece of jewelry. Consistent with this embodiment a metal sample is created and treated by the process to create a piece of jewelry. The sample may comprise a metal alloy, a metal carbide, a metal nitride, a metal salt, metal sulfide or any combination of these metals. In step 102, metal powders are mixed together to form the sample. In one embodiment, the sample may include a binder such as, but not limited to, a polymer, plastic, wax, resin, or any other material which is capable of binding metal powders together.

In step 104, the metals making up the sample are pressed together. In one embodiment, the metals are pressed together using a compression device such as a mechanical press. In another embodiment, the sample is pressed together or formed into a first predetermined shape using a Metal Injection Molding (“MIM”) process. Consistent with this embodiment, the metals and binder comprising the sample are placed into a mold and compressed under pressure. In one embodiment, the MIM process utilizes a Hydraulic High Pressure Briquette machine which creates the sample by compressing at least two metals and a binder together. In another embodiment, the MIM process utilizes a cold isostatic presses/pressing machine which uses a fluid as a means of applying pressure to the mold at room temperature. In another embodiment, the MIM process utilizes a cold compacting presses/machines. Consistent with this embodiment, the cold compaction compresses powder materials in a temperature region where high temperature deformation mechanics like dislocation or diffusional creep can be neglected.

In step 106, the sample is subjected to an optional soaking process where the sample is placed into a gas container where it is heated to a first temperature over a first time period. In one embodiment, the sample is heated from a starting temperature to the first temperature over the entire span of the first time period. Consistent with this embodiment, the heating may occur linearly over the first time period or in steps with each step bringing a predetermined increase in the temperature of the sample. In one embodiment utilizing the step approach, each step increases the temperature of the sample by an equal amount. In another embodiment utilizing the step approach, each step increases the sample temperature by different amounts. In another embodiment, the linear heating approach increases the temperature of the sample such that the sample temperature corresponds to a linear equation such as y(temp)=m(time)+b. In another embodiment, the heating of the sample increases the temperature of the sample such that the sample temperature corresponds to a substantially parabolic curve. In one embodiment of the soaking process, the first time period is fixed to a predetermined value. In another embodiment, the first time period is variable.

After the sample temperature has reached the first temperature, the sample is removed from the gas container and is air dried for a second time period. During the drying process, the sample is allowed to cool to a second temperature. In one embodiment, the second temperature is substantially equal to the first temperature. In another embodiment, the second temperature is substantially equal to the ambient temperature. In another embodiment, the second temperature is lower than ambient temperature. In yet another embodiment, the second temperature is higher than the ambient temperature.

The first temperature is set to a value where a binder is separated from the sample. In one embodiment, the first temperature is lower than the temperature required to melt the sample. The soaking process is effective to remove up to about 90% of the binder from the metal before the sintering process begins. Another process of removing a binder from a sample is disclosed in U.S. Pat. No. 5,021,208, titled “Method for removal of paraffin wax based binders from green articles” is herein incorporated in its entirety by reference.

In step 108, the sample is subjected to a pre-sintering process. In one embodiment of the pre-sintering process, the sample is heated from to a first temperature over a first time period. In one embodiment, the sample is heated over the first time period using the linear, non linear or step heating methods previously discussed. Once the sample is heated to the first temperature, the sample is then heated over a second time period to a second temperature using the linear, non linear or step heating methods previously discussed. Once the sample reaches the second temperature, the sample is heated to a third temperature over a third time period using the linear, non linear or step heating methods previously discussed.

Once the sample reaches the third temperature, the sample is heated to and held at a fourth temperature for a fourth time period. In one embodiment, the fourth temperature is a temperature range at which the sample is held over the fourth time period. Consistent with this embodiment, the sample may continue to heat and cool over the fourth time period. Once the fourth time period has expired, the sample is allowed to cool to a fifth temperature over a fifth time period. In one embodiment, the fifth temperature is substantially equal to ambient temperature. In another embodiment, the fifth temperature is below ambient temperature. In yet another embodiment, the fifth temperature is above ambient temperature. In one embodiment, the sample is naturally cooled in the open atmosphere.

The first through fourth temperatures and time periods are selected such that the sample is heated but not sintered. In one embodiment, the first through fourth temperatures are selected such that the sample is heated to a point where the fusion of the metals in the sample has begun, but the sample is not completely sintered. In another embodiment, the first through fourth temperatures are selected such that the sample is heated to a point where the fusion of metal has not begun. In another embodiment, the sample is heated to a temperature where the sample is almost completely sintered. In one embodiment, the first through fourth temperatures are selected to achieve a specific hardness of the sample after the pre-sintering is complete. Consistent with this embodiment, the temperatures are selected independent of the level of sintering achieved in the sample. In one embodiment, the metal comprises 85%-90% Tungsten Carbide and the hardness after the pre-sintering is about HV200 on a Vickers Hardness Scale which is lower than the full hardness, about HV 900 of the fully sintered sample, where the sample comprises Tungsten Carbide. The total time to pre-sinter the sample is based on the type of metals, matrix binders and binders in the sample, as well as the pressure at which the pre-sintering occurs. In one embodiment the first through fourth temperatures are predetermined temperatures. In another embodiment, the total time to pre-sinter the sample is a predetermined period of time. In another embodiment, the first through fourth temperatures and total time to pre-sinter the sample will vary depending on the plurality of sinterable materials and/or pressure. In another embodiment, the total time to pre-sinter the sample exceeds about 2 hours.

In one embodiment, the cooling of the sample to the fifth temperature is performed in an environment having a temperature either above ambient temperature, below ambient temperature, at ambient temperature or any combination. In another embodiment, the cooling of the sample to the fifth temperature can take from about 10-15 hours. In another embodiment, the cooling to the fifth temperature can be accelerated using artificial cooling, including, for example, air conditioning, liquid nitrogen or other chemical compounds, an ice bath, a wash or dousing with water or another liquid or gas. In another aspect, the cooling to the fifth temperature can be accomplished by any other cooling method now known or hereafter discovered or developed.

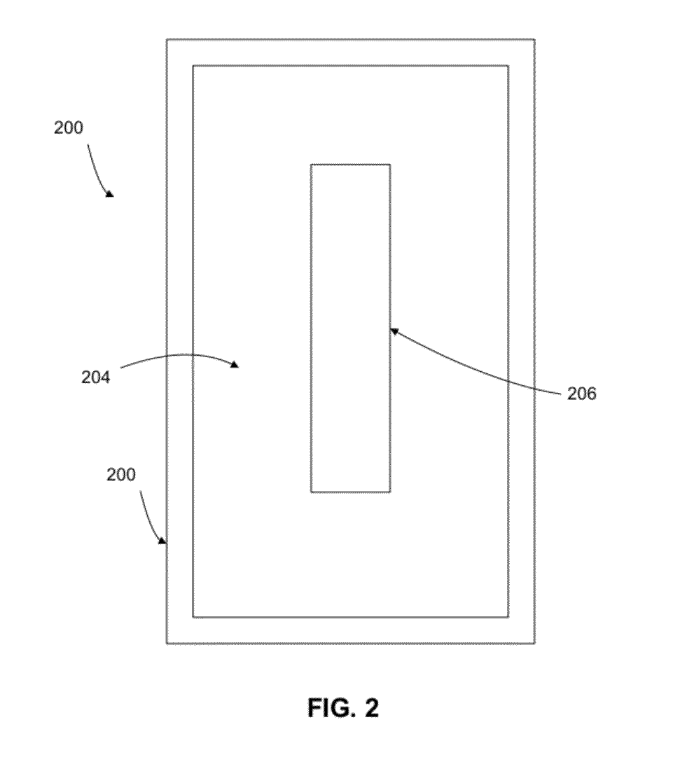

FIG. 2. depicts one embodiment of a hot/cold isostatic pressing device 200 used to pre-sinter a sample. The isostatic pressing device 200 includes a pressure vessel 202 having a cavity 204 in the center which is sized to accommodate the sample 206. In one embodiment, pressure is applied to the sample 206 by injecting a gas under pressure into the cavity 204. In another embodiment, heat is applied to the sample 206 in the cavity 204 simultaneously to the pressure being applied to the sample 206. In one embodiment, the sample 206 is heated using a heater in the cavity 204. In another embodiment, the gas in the cavity 204 is pre heated before entering the cavity 204. By pressurizing the cavity 204 while applying heat, the amount of heat required to partially fuse the metals in the sample 206 together and remove the binder is reduced. In another embodiment, the pressure in the cavity 204 is held at a constant level while the temperature in the cavity 204 is adjusted using the pre-sintering method described above.

In one embodiment, the sample 206 is composed of 85%-90% Tungsten Carbide and the pressure applied to the sample is 2000 bar and the sample 206 is heated to a temperature up to about 2000 degrees C. In one embodiment, the gas used to apply pressure to the sample is one of Argon, Nitrogen, Oxygen or any other gas capable of applying pressure to the sample in the cavity 204. In another embodiment, the sample 206 partially sintered under pressure without heat. In another embodiment, the pre-sintering process only subjects the sample to minimal or no heating. Consistent with this embodiment, the metal is pressed together and then subjected to the milling step with a minimal amount of heat applied to the sample.

Returning to FIG. 1, the first through fourth temperatures and heating times, the level of sintering, and resulting sample hardness are based on the type, combination and concentration of metals in the sample. Accordingly, the temperature values and heating times will vary based on the composition of the sample. Examples using Tungsten Carbide are discussed below.

After the pre-sintering process is complete, the sample is milled. In one embodiment, the sample is milled using a Computer Numerical Control (“CNC”) milling machine. In one embodiment, the tool approach of the CNC milling machine is from 0.01 mm/s to 0.50 mm/s. In another embodiment, the tool spinning is at 20,000 RPM to 50,000 RPM. Consistent with this embodiment, the sample is heated. Since the sample has not been fully sintered, the sample is engraved and formed by the CNC milling machine using conventional components. In one embodiment, the sample is milled immediately after reaching the fourth temperature where the fourth temperature is set to a value where the metal is malleable, but not sintered. In another embodiment, the sample is milled after being cooled from the fourth temperature to a fifth temperature.

In another embodiment, the sample is heated to a temperature where the sample can be manipulated using hand tools. Because the pre-sintered sample is not completely fused, it is possible to use traditional hand held jewelry tools to impart a pattern or texture by hand. In one embodiment, the sample is manipulated using any one of a flexible shaft machine, a high speed grinding burr, stainless steel sculpting/carving knife, a drill, sculpting knife or any other suitable tool for making jewelry.

After the milling process, the sample is sintered in step 112. In one embodiment, the sample, at a first sintering temperature, is placed into a vacuum oven where it is heated to a second sintering temperature over a first sintering time period using any of the previously discussed heating methods. Once the sample reaches the second sintering temperature, the sample is heated to a third sintering temperature over a second sintering time period. Once the sample reaches the third sintering temperature, the sample is heated to a fourth sintering temperature over a third sintering time period. Once the sample reaches the fourth sintering temperature, the sample is heated to a fifth sintering temperature over the fourth sintering time period. Once the sample reaches the fifth sintering temperature, the sample is held at the fifth sintering temperature for a fifth time period. Once the fifth time period expires, the sample is allowed to cool.

In one embodiment, the sample is naturally cooled. In another embodiment, the sample is cooled using a cooling device such as an air conditioning unit, cooler or other cooling device. During the sintering process, the sample is heated over each time period linearly, in a step mode or in a curved mode as previously discussed. In one embodiment, the sample is heated in the same manner over each time period. In another embodiment, the sample is heated in a different manner over each time period. In another embodiment, the sample is heated using different methods in a single time period. Another process for sintering jewelry is also disclosed in U.S. Pat. No. 6,062,045, titled “WEAR RESISTANCE JEWELRY” which is herein incorporated in its entirety by reference.

In one embodiment, the cooling of the sample is performed in an environment having a temperature either above ambient temperature, below ambient temperature, at ambient temperature, or any combination. In another embodiment, the cooling of the sample can take from 10-15 hours from the sixth temperature. In another embodiment, the cooling can be accelerated using artificial cooling, including, for example, air conditioning, liquid nitrogen or other chemical compounds, an ice bath, a wash or dousing with water or another liquid or gas. In another aspect, the cooling can be accomplished by any other cooling method now known or hereafter discovered or developed.

In another embodiment, the sintering temperatures and sintering times are based on the type of metals and binders in the sample, as well as the pressure under which the sintering occurs. In another embodiment, the heating to the fifth sintering temperature occurs for a time period exceeding about 2 hours. In one embodiment, the temperatures used in the sintering process are between about ambient temperature and about 1600° C.

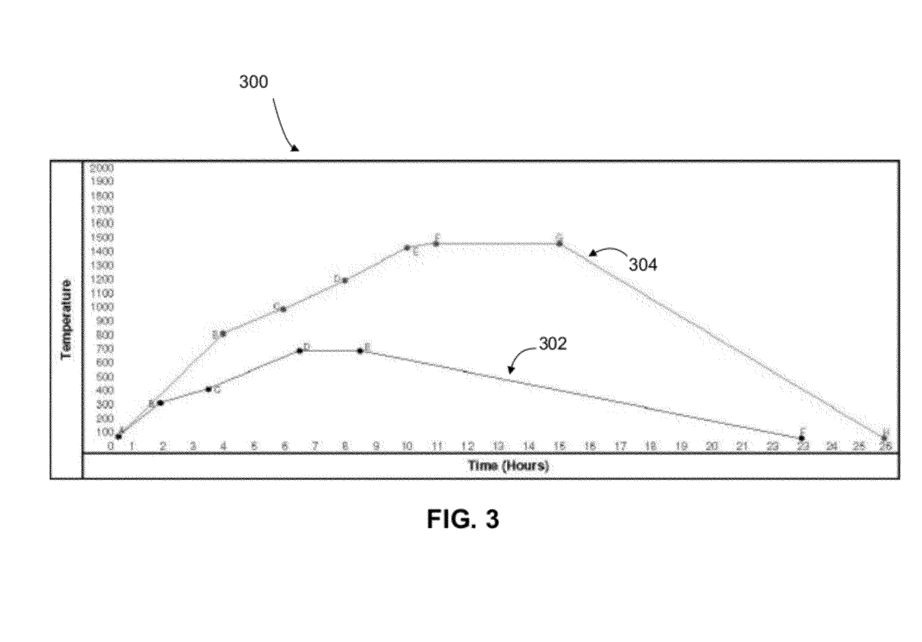

FIG. 3 depicts one embodiment of a graph of the temperatures used to heat a 85%-90% Tungsten Carbide sample. As the graph depicts, the pre-sintering process 302 is conducted at a lower temperature than the sintering process 304. Accordingly, the sample is not fully sintered at the end of the pre-sintering process, but is fully sintered at the end of the sintering process. In one embodiment, the sample has a hardness of about HV 900 on the Vickers Harness Scale after the sintering process. After the sintering is complete, the sample is subjected to a grinding and tumbling process 114 and is then polished 116.

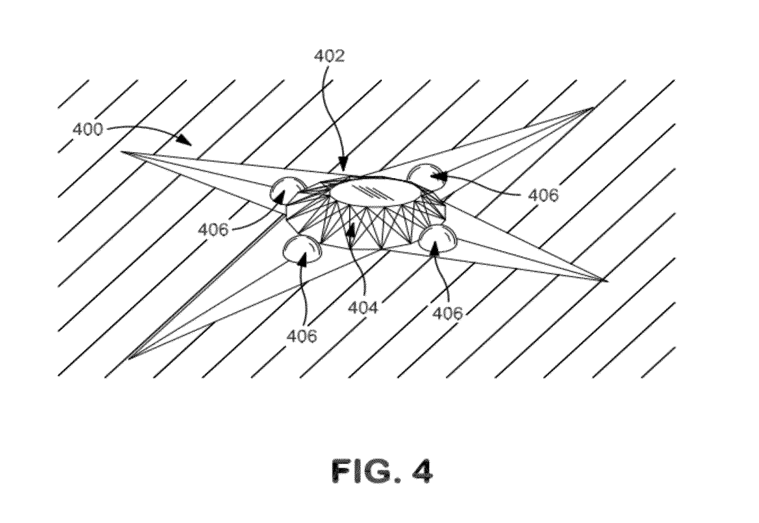

FIG. 4 depicts one embodiment of a sample 400 that is milled into a gem setting. Consistent with this embodiment, the sample 400 is pre-sintered before being milled. The sample includes a center cavity 402 which is sized to accommodate a gem stone 404 and holding units 406 which are milled into the sample 400 to hold a gem stone 404 in the cavity 402. In one embodiment, the holding units 406 are additional gem stones adhered to cavities milled into the surface of the sample 400. In one embodiment, the sample 400 comprises Tungsten Carbide. In another embodiment, the sample 400 comprises 85%-90% Tungsten Carbide.

FIG. 5A depicts one embodiment of a sample 500 milled into a channel setting. The sample 500 includes a channel 502 milled into the top surface of the sample 500. In one embodiment, the channel 502 has a uniform width and depth throughout the length of the channel 502. In another embodiment, the channel has an variable width and depth throughout the length of the channel 502. In the case of a variable channel 502, the variability of the width and curvature may be accomplished using a carving method. FIG. 5B depicts a side view of the sample 500 along section A-A having the channel 502 milled through the upper portion of the sample 500. The channel 502 includes two lips 504 on the opposing sides of the channel 502 which are sized to accommodate a gem stone and prevent the gem stone from being removed from the channel 502. FIG. 5C depicts a side view of the sample 500 along section B-B showing the channel 502 positioned on one side of the top portion of the sample 500. In one embodiment, the sample 500 comprises Tungsten Carbide. In another embodiment, the sample 500 comprises 85%-90% Tungsten Carbide. In one embodiment, the sample 500 comprises less than 10% by weight of a matrix binder. In another aspect, the jewelry article comprises greater than 5%, between 10 and 20%, between 20 and 30%, between 30 and 40%, between 40 and 50%, between 50 and 60%, between 60 and 70%, and greater than 70% by weight of the matrix binder. In one embodiment, the sample 500 includes less than 40%, between 40 and 50%, between 50 and 60%, between 60 and 70%, between 70 and 80%, between 80 and 90% of at least one of tungsten carbide, cobalt, tungsten, titanium, titanium carbide, zirconium, tantalum, aluminum, rhodium, gold, silver, platinum, palladium, iridium, iron, stainless steel, cobalt chrome, cobalt chromium, nickel, nitinol, aluminum, aluminum carbide, vanadium, ruthenium, copper, zinc, tin, German silver, niobium, molybdenum, rhenium and hafnium, in various forms, including, for example, powdered form.

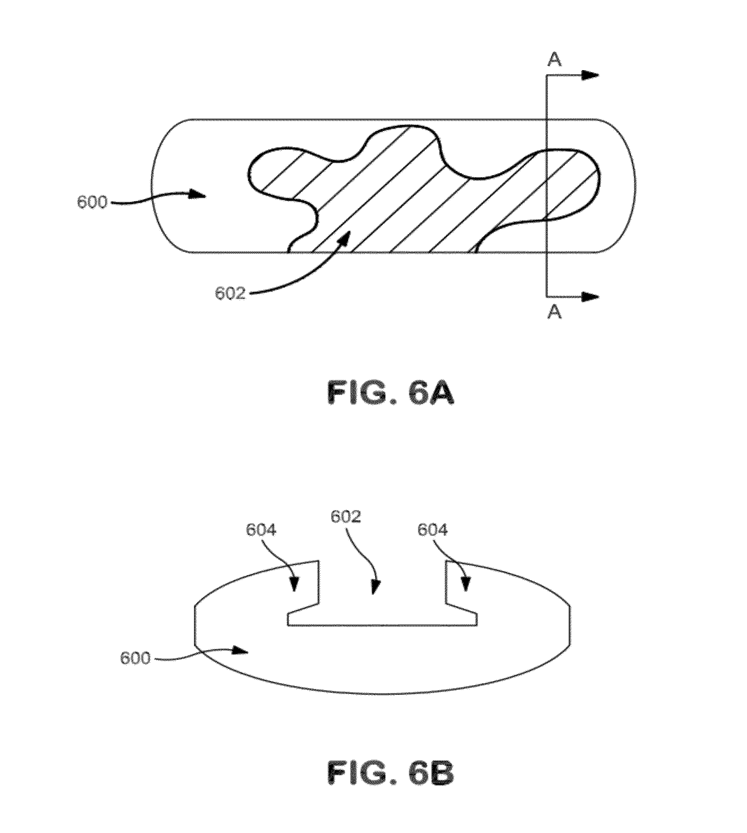

FIG. 6A depicts one embodiment of a sample 600 milled with an “odd shaped” precious metal inlay in the top surface of the sample 600. FIG. 6B depicts a side view of the sample 600 along section A-A showing a channel 602 milled into the center of the top portion of the sample 600. The channel 602 includes two lips 604 on the opposing sides of the channel 602 which are sized to accommodate the inlay and prevent the inlay from being removed from the channel 602. The inlay can be burnished into and under the two lips 604 to provide for anchoring of the inlay. In one embodiment, the sample 600 comprises Tungsten Carbide. In another embodiment, the sample 600 comprises 85%-90% Tungsten Carbide. In one embodiment, the sample 600 comprises less than 10% by weight of the matrix binder. In another aspect, the jewelry article comprises greater than 5%, between 10 and 20%, between 20 and 30%, between 30 and 40%, between 40 and 50%, between 50 and 60%, between 60 and 70%, and greater than 70% by weight of a matrix binder. In one embodiment, the sample 600 includes less than 40%, between 40 and 50%, between 50 and 60%, between 60 and 70%, between 70 and 80%, between 80 and 90% of at least one of tungsten carbide, cobalt, tungsten, titanium, titanium carbide, zirconium, tantalum, aluminum, rhodium, gold, silver, platinum, palladium, iridium, iron, stainless steel, cobalt chrome, cobalt chromium, nickel, nitinol, aluminum, aluminum carbide, vanadium, ruthenium, copper, zinc, tin, German silver, niobium, molybdenum, rhenium and hafnium, in various forms, including, for example, powdered form.

### EXAMPLES

The following examples are included to demonstrate preferred embodiments of the disclosure. It should be appreciated by those of skill in the art that the techniques disclosed in the examples which follow represent techniques discovered by the inventors to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the concept, spirit and scope of the invention. More specifically, it will be apparent that certain agents which are both chemically and physically related may be substituted for the agents described herein while the same or similar results would be achieved. All such similar substitutes and modifications apparent to those skilled in the art are deemed to be within the spirit, scope and concept of the invention as defined by the appended claims.

### Example 1

In one example of the present disclosure, a tungsten carbide substrate or part comprising a paraffin based binder is subjected to a preparation process in an oxidizing atmosphere such as oxygen. The substrate or part is heat treated at a temperature of between about 0° C. and about 300° C. for about 2 hours, followed by an increase in temperature to about 300° C.-400° C. for a time period of about 1.5 hours. The substrate or part is further heated to a temperature of about 400° C.-650° C. for a time period of about 3 hours, followed by a subsequent heating period at a temperature of about 650° C. for a time period of about 2 hours. The substrate or part is then cooled to an ambient temperature for a time period of about 10-15 hours. The preparation process is effective to remove the paraffin binder from the substrate or part.

The substrate or part is then manipulated using a CNC machine tool to create a design feature in the substrate or part. For example, the design feature can include one or more of the following: numbers, letters, logos, stone settings, textures, other embellishments.

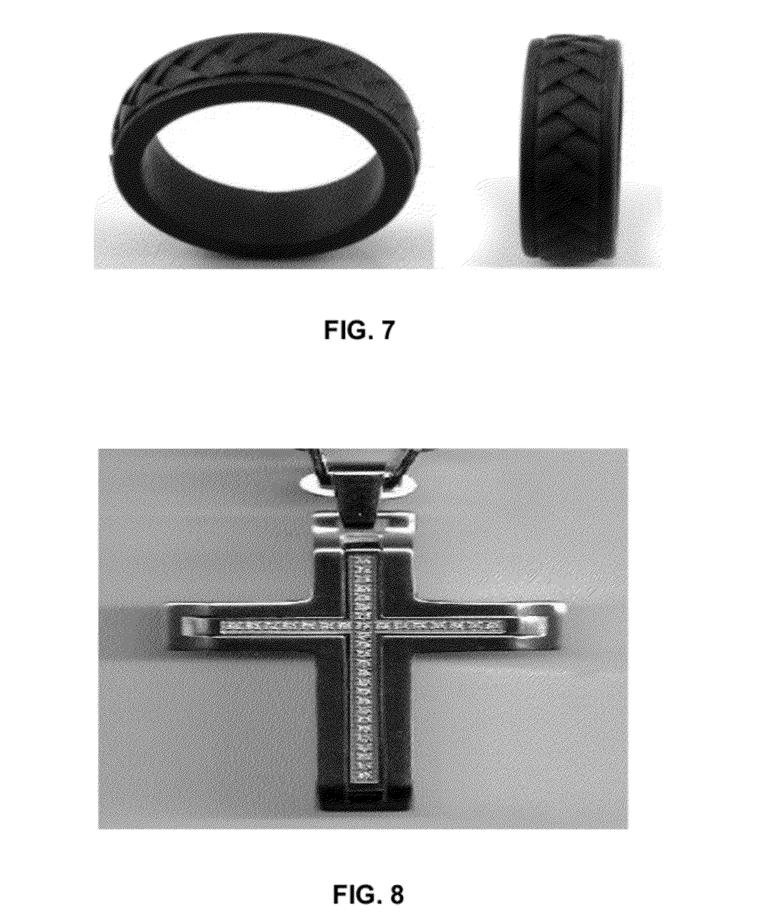

The substrate or part is then subjected to a secondary sintering process in a vacuum furnace comprising an inert atmosphere such as nitrogen. The substrate or part is heat treated at a temperature of between about 0° C. and about 800° C. for about 4 hours, followed by an increase in temperature to about 800° C.-1000° C. for a time period of about 2 hours. The substrate or part is further heated to a temperature of about 1000° C.-1200° C. for a time period of about 2 hours, followed by an increase in temperature to about 1200° C.-1400° C. for a time period of about 2 hours. The substrate or part is then heated to a temperature of about 1400° C.-1450° C. for a time period of about 1 hour, followed by a subsequent heating period at a temperature of about 1450° C. for a time period of about 4 hours. The substrate or part is then cooled to an ambient temperature for a time period of about 8-10 hours, resulting in a sintered tungsten carbide material having the design feature, as shown in FIG. 7 and FIG. 8.

### Example 2

In another example of the present disclosure, a substrate or part comprising a metallic powder or partially metallic powder is treated with a binder such as paraffin wax. The substrate or part is then subjected to a soaking process using an organic chemical substrate or part such as a petroleum product or derivative such as gasoline for assisting in the removal of the binder. The soaking process may be performed in a suitable container beginning at an ambient temperature followed by a temperature increase to between about 55° C. and about 75° C. The resulting substrate or part is dried in an oxidizing atmosphere, such as air, for a period between about 3-5 hours. The substrate or part is then placed onto a surface capable of heating the substrate or part, such as a heat conductive plate, and inserted into an oven under non-evacuated/non-vacuum conditions.

The substrate or part is heated from an ambient temperature to a temperature between about 250° C. and about 300° C. for about 1.5-2.5 hours, followed by heating to a temperature between about 350° C. and about 400° C. for about 1-2 hours. The substrate or part is then heated to a temperature between about 600° C. and about 650° C. for about 2.5-3.5 hours, followed by heating at a temperature maintained between about 600° C. and about 700° C. for about 1.5-2.5 hours. The substrate or part is then cooled to about ambient temperature, resulting in a substrate or part capable of being manipulated, for example, using hand tools, CNC, or other tools, techniques and machinery known to the skilled artisan, prior to sintering. Alternatively, the substrate or part can be cooled to any temperature whereby the substrate or part may be manipulated.

### Example 3

In yet another example of the present disclosure, a substrate or part comprising a metallic powder or partially metallic powder is treated with a binder such as paraffin wax to create a green ring blank comprising between about 2% and about 10% nickel or an alloy or carbide thereof, between about 1% and about 2% cobalt or an alloy or carbide thereof, between about 0.5% and about 3% chromium or an alloy or carbide thereof and the remainder of the material comprising tungsten or an alloy or carbide thereof, including but in no way limited to tungsten carbide. In another embodiment, the binders may be palladium, platinum, ruthenium, iridium and gold or alloys thereof. In another embodiment, the green ring blank is of a ceramic composition comprising about 99% of ZrO₂+Hf0₂; 0.20% of SiO₂; 0.15% of TiO₂; 0.02% of Fe₂O₃; 0.25% of SO₃; and 0.30% of LOI, which can be heated to 1440 Deg C. for sintering. Consistent with this embodiment, when ZrO₂+HfO₂ is used, a matrix material may include silicon nitrides, silicon carbides and other similar materials. In one embodiment, castoring agents may also be used with the ZrO₂+HfO₂.

In one embodiment, the powder mixture comprises tungsten and one or more of titanium carbide (Tic), chromium carbide (Cr, C,), nickel, molybdenum, vanadium carbide (VC) and iron. In the preferred embodiments, the powder mixture comprises tungsten, titanium carbide, chromium carbide, nickel, molybdenum, vanadium carbide and iron. The weight percentage range of each component in the mixture may vary depending on the desired physical properties and/or aesthetic appearance of the jewelry article.

In general, the weight percent of tungsten in the mixture is less than about 50%. Preferably, the tungsten weight percent is about 20-50%, and most preferably about 40-50%. The powder mixture may comprise about 15-25%, preferably about 21-22% titanium carbide. The chromium carbide content may be about 15-25%, preferably about 19-21%. Additionally, the nickel content may be about 15-25%, preferably about 22-23%. Further, molybdenum and vanadium carbide combined amount may be about 5-10%, preferably between 7-8%. Finally, the iron content may be about 1-5%, preferably about 2-3%. All percent ranges described herein are by weight and include every individual value within each range. In a non-limiting example, the mixture comprises about 21-22% titanium carbide, about 20% chromium carbide, about 45% tungsten, about 22-23% nickel, about 7-8% molybdenum and vanadium carbide combined, and about 2-3% iron.

The substrate or part is optionally subjected to a pressure or series of pressures exceeding ambient pressure, resulting in a substrate or part capable of being manipulated, for example, using hand tools, CNC, or other tools, techniques and machinery known to the skilled artisan, in the absence of heating said substrate or part to a temperature or series of temperatures exceeding ambient temperature(s).

All of the methods and compositions disclosed and claimed herein can be made and executed without undue experimentation in light of the present disclosure. While the compositions and methods of this disclosure have been described in terms of preferred embodiments, it will be apparent to those of skill in the art that variations may be applied to the compositions and methods and in the steps or in the sequence of steps of the method described herein without departing from the concept, spirit and scope of the invention. More specifically, it will be apparent that certain agents and components which are both chemically and physically related may be substituted for the agents described herein while the same or similar results would be achieved. All such similar substitutes and modifications apparent to those skilled in the art are deemed to be within the spirit, scope and concept of the invention as defined by the appended claims.

The following references are incorporated by reference herein in their entirely: U.S. Pat. No. 6,544,315, title “Sintered Jewelry and Decorative Articles”; U.S. Pat. No. 6,553,667, titled “Apparatus and Method for Manufacturing Composite Articles Including Wear Resistant Jewelry and Medical and Industrial Devices and Composites Thereof”; U.S. Pat. No. 6,990,736, titled “Methods for Preparing Jewelry Articles Comprising Sintered Tungsten Carbide”; U.S. Pat. No. 6,993,842, titled “Methods and Jewelry Articles Comprising Sintered Tungsten Carbide”; U.S. Pat. No. 7,032,314, titled “Methods of Making Tungsten Carbide-Based Annular Jewelry Rings”; U.S. Pat. No. 7,076,972, titled “Tungsten Carbide-Based Annular Jewelry Article”; U.S. application Ser. No. 12/141,791, titled “Tungsten Ring Composition”; U.S. Pat. No. 7,761,996, titled “Methods of Making Tungsten Carbide-Based Annular Jewelry Rings”; U.S. Pat. No. 8,061,033, titled “Methods of Making Tungsten Carbide-Based Annular Jewelry Rings”; U.S. Pat. App. Ser. No. 61/492,197, filed Jun. 1, 2011; U.S. Pat. App. Ser. No. 61/493,249, filed Jun. 3, 2011; U.S. Pat. App. Ser. No. 61/493,283, filed Jun. 3, 2011; U.S. patent application Ser. No. 13/152,226, filed Jun. 2, 2011, titled “Multi-Coated Metallic Articles and Methods of Making Same”; Dobkin et al., “Principles of Chemical Vapor Deposition,” Springer, New York (2003); and Mahan, “Physical Vapor Deposition of Thin Films,” Wiley-Interscience, New York (2000).

1. A method for producing a jewelry article, comprising:
forming a predetermined shape from a plurality of materials;
heating the plurality of materials to a first temperature and for a first period of time sufficient to produce a substrate that retains the predetermined shape during manipulation;
cooling the substrate such that the substrate is manipulable;
manipulating the substrate to incorporate at least one design feature in the substrate;
heating the substrate to a second temperature and for a second period of time sufficient to sinter the substrate; and
cooling the substrate to obtain the jewelry article.

2. The method of claim 1, wherein the heating of the plurality of materials to a first temperature and for a first period of time is sufficient to result in a pre-sintering but not sufficient to result in a sintering of at least a portion of the plurality of materials.

3. The method of claim 1, wherein the design feature is non-functional.

4. The method of claim 1, wherein the manipulating is a first manipulation and further comprising:
performing a second manipulation on said substrate.

5. The method of claim 4, wherein the second manipulation is performed after the second cooling.

6. The method of claim 1, wherein the first temperature is between about ambient temperature and at least one of about 650° C. and about 800° C.

7. The method of claim 1, wherein said heating to the first temperature occurs for a time period between about 2 hour and about 18 hours.

8. The method of claim 1, wherein said cooling is performed at a second temperature of between about ambient temperature and at least one of about 1450° C. and about 2200° C.

9. The method of claim 1, where said cooling occurs for a time period between about 2 hour and about 15 hours.

10. The method of claim 1, wherein at least one of said first manipulation and said second manipulation is selected from the group consisting of patterning, surface modulating, etching, carving, faceting, cutting, pressing, molding, casting, striking, extruding, inlaying, shaping, polishing, tumbling, grinding, drilling, sculpting, scoring, scraping, rubbing sanding, buffing and filing.

11. (canceled)

12. The method of claim 1, wherein said jewelry article is a ring, ornamental ring, engagement ring, toe ring, watch, bracelet, necklace, pendant, charm, armlet, brocade, pin, clip, hairclip, fob, ornamental piercing, earring, nose ring, dog tag, amulet, bangle bracelet, cuff bracelet, link bracelet, cuff link, key chain, money clip, cell phone charm, signet ring, class ring, friendship ring or purity ring.

13. The method of claim 1, wherein said jewelry article is a wedding band.

14. The method of claim 1, wherein said jewelry article is optionally layered with a first coating.

15. The method of claim 14, wherein at least one of said first coating and said second coating is deposited onto the substrate using electroplating, physical vapor deposition (PVD) or chemical vapor deposition (CVD).

16. The method of claim 14, wherein said first coating is optionally layered with a second coating.

17. (canceled)

18. The method of claim 1, wherein said substrate comprises at least one of a metal salt, metal alloy, metal carbide, metal nitride, metal sulfate, metal chlorate, metal sulfide and metal boride.

19. The method of claim 14, wherein said first coating is selected from the group consisting of a metal salt, metal alloy, metal carbide, metal nitride and metal boride.

20. The method of claim 16, wherein said second coating is selected from the group consisting of a metal salt, metal alloy, metal carbide, metal nitride, metal sulfate, metal chlorate, metal sulfide and metal boride.

21. A method for producing a jewelry article, comprising:
forming a part, comprising a plurality of materials and a binder, into a first predetermined shape that has sufficient stability to allow its manipulation prior to sintering such that a second predetermined shape can be formed;
manipulating the part to form the second predetermined shape;
heating the part to a first temperature and for a first time period sufficient to sinter the part; and
cooling the part to obtain the jewelry article.

22. The method of claim 21, wherein the first temperature is a predetermined temperature and the first time period is a predetermined time period.

23. The method of claim 21, wherein the second predetermined shape is a design feature.

24. The method of claim 23, wherein the design feature is non-functional.

25. The method of claim 21, wherein the manipulating is a first manipulation and further comprising:
performing a second manipulation on said substrate.

26. (canceled)

27. The method of claim 21, wherein said heating is performed at a temperature of between about ambient temperature and about 1450° C.

28. The method of claim 21, wherein said heating occurs for a time period between 2 and 18 hours.

29. The method of claim 21, wherein said cooling is performed at at least one of ambient temperature, above ambient temperature and below ambient temperature.

30. The method of claim 21, wherein said cooling occurs for a time period between about 2 hour and about 15 hours.

31. The method of claim 25, wherein at least one of said first manipulation and said second manipulation is selected from the group consisting of patterning, surface modulating, etching, carving, faceting, cutting, pressing, molding, casting, striking, extruding, inlaying, shaping, polishing, tumbling, grinding, scraping, rubbing, sanding, buffing and filing.

32-41. (canceled)

42. The method of claim 1, wherein the substrate includes a binder selected from the group consisting of a polymer, plastic, binder, wax, rubber and resin.

43. The method of claim 42, wherein the binder leaches out of the substrate prior to obtaining the jewelry article.

44. The method of claim 1, wherein the plurality of materials comprises at least one of tungsten carbide, cobalt, tungsten, titanium, titanium carbide, zirconium, tantalum, aluminum, rhodium, gold, silver, platinum, palladium, iridium, iron, stainless steel, cobalt chrome, cobalt chromium, nickel, nitinol, aluminum, aluminum carbide, vanadium, ruthenium, copper, zinc, tin, German silver, niobium, molybdenum, rhenium and hafnium.

45-47. (canceled)

48. The method of claim 1, wherein the plurality of materials comprises at least 90% by weight of tungsten carbide, cobalt, tungsten, titanium, titanium carbide, zirconium, tantalum, aluminum, rhodium, gold, silver, platinum, palladium, iridium, iron, stainless steel, cobalt chrome, cobalt chromium, nickel, nitinol, aluminum, aluminum carbide, vanadium, ruthenium, copper, zinc, tin, German silver, niobium, molybdenum, rhenium and hafnium.

49. (canceled)

50. The method of claim 1, wherein the plurality of materials comprises at least one of less than 40%, between 40 and 49%, between 50 and 59%, between 60 and 69%, between 70 and 79% and between 80-89% by weight of tungsten carbide, cobalt, tungsten, titanium, titanium carbide, zirconium, tantalum, aluminum, rhodium, gold, silver, platinum, palladium, iridium, iron, stainless steel, cobalt chrome, cobalt chromium, nickel, nitinol, aluminum, aluminum carbide, vanadium, ruthenium, copper, zinc, tin, German silver, niobium, molybdenum, rhenium and hafnium.

51. (canceled)

52. The method of claim 4, wherein the second manipulation step results in a surface that is contiguous and disposed circumferentially.

53. (canceled)

54. A sintered jewelry article, comprising:
a substrate having a design feature, prepared by a process comprising:
forming a predetermined non-functional shape from a plurality of materials;
heating the plurality of materials to a first temperature and for a first time period sufficient to produce a substrate that retains the predetermined shape during manipulation;
cooling the substrate to a second temperature at which the substrate is manipulable;
manipulating the substrate to incorporate at least one design feature in the substrate;
heating the substrate to a third temperature and for a second time period sufficient to sinter the substrate; and
cooling the substrate.

55. The method of claim 1, wherein the first manipulation is performed using at least one of a CNC machine, a laser, photo lithography, a water jet, a lathe, a tumbler, a drill, a saw, a file, a tool, power tools and hand tools.

56-57. (canceled)

58. The method of claim 1, wherein said method is performed in an atmosphere comprising one or more of air, argon, nitrogen, and oxygen.

59-60. (canceled)

61. The method of claim 42, wherein said binder is selected from the group consisting of carving wax, injection wax, ferris wax, matt wax, a wax sheet, a wax wire, clay, mold rubber, Castaldo® rubber, Contenti rubber, plastic casting and plastic molding.

62. The method of claim 2 wherein the substrate is 85%-90% Tungsten Carbide and the second temperature is between 1300 and 1500 degrees C.

63-64. (canceled)

65. The method of claim 54, wherein said heating to the third temperature occurs for a time period between about 2 hour and about 18 hours.

66. The method of claim 54, wherein the second temperature is at least one of above and below ambient temperature.

67. (canceled)

68. The method of claim 1, wherein the substrate is cooled by natural cooling.

69. The method of claim 1, wherein the substrate is cooled by a mechanical cooling device.

70. The method of claim 1, wherein the first temperature is a predetermined temperature.

71. The method of claim 1, wherein the first period of time is a predetermined period of time.

72. The method of claim 1, wherein the second temperature is a predetermined temperature.

73. The method of claim 1, wherein the second period of time is a predetermined period of time.

74. The method of claim 1, wherein the first temperature and the first period of time will vary depending on the plurality of sinterable materials or pressure.

75. The method of claim 1, wherein the second temperature and the second period of time will vary depending on the plurality of sinterable materials or pressure.

76. The method of claim 1, wherein the design feature can be functional or non-functional.

77. The method of claim 1, wherein the manipulating is a first manipulation and further comprising performing a second manipulation on the substrate or part.

78. The method of claim 77, wherein the second manipulation is performed after the second cooling.

79. The method of claim 1, wherein the first temperature is a predetermined temperature that will vary depending on the type of materials used and the pressure.

80. The method of claim 1, wherein the first temperature is a plurality of temperatures for varying periods of time.

81. The method of claim 1, wherein the first temperature is a temperature range which varies from 0 to 300 for 2 hours, from 300 to 400 for 1.5 hours, from 400 to 650 for 3 hours and at 650 for 2 hours.

82. The method of claim 1, wherein the heating to the first temperature occurs for a time period exceeding about 2 hours.

83. The method of claim 1, wherein the second temperature is a plurality of temperatures for varying periods of time.

84. The method of claim 1, wherein the second temperature is a temperature range which varies from 0 to 800 for 4 hours, from 800 to 1000 for 2 hours, from 1000 to 1200 for 2 hours, from 1200 to 1400 for 2 hours, from 1400 to 1450 for 1 hour and at about 1450 for 4 hours.

85. The method of claim 22, wherein the predetermined temperature and/or the predetermined time period may vary depending on the type of materials and pressure.

86. The method of claim 22, wherein the predetermined temperature is between about ambient temperature and about 1600° C.

87. The method of claim 22, wherein predetermined time period is between 2 and 72 hours.

88. The method of claim 1, wherein the cooling takes from about 2-10 hours from the second temperature.

89. The method of claim 21, wherein the cooling is accelerated using artificial cooling

90. The method of claim 89, wherein the artificial cooling comprises are least one of air conditioning, liquid nitrogen, an ice bath, and a water wash.

91. The method of claim 21, wherein the heating occurs for a time period between about 2 hour and about 72 hours.

92. The method of claim 54, wherein the substrate includes at least one matrix binder selected from the group consisting of nickel, cobalt, titanium, zirconium, tantalum, aluminum, rhodium, gold, silver, platinum, palladium, iridium, iron, stainless steel, cobalt chrome, cobalt chromium, nickel, nitinol, aluminum, vanadium, ruthenium, copper, zinc, tin, german silver, niobium, molybdenum, rhenium and hafnium.

93. (canceled)

94. The method of claim 1, wherein the jewelry article comprises less than 10% by weight of the matrix binder.

95. The method of claim 1, wherein the jewelry article comprises greater than 5%, between 10 and 20%, between 20 and 30%, between 30 and 40%, between 40 and 50%, between 50 and 60%, between 60 and 70%, and greater than 70% by weight of a matrix binder.

96. The method of claim 1, wherein the manipulation includes adding a setting to the substrate or part, such as, for example, a channel, bezel, prong or pave setting.

97. The method of claim 1, wherein the predetermined shape is formed using a mim process.

98. The method of claims 1, wherein the materials are sinterable materials.

99. The method of claims 1, wherein the materials are powdered metals or powdered materials with metallic properties.
